(19) United States
(12) Patent Application Publication
(10) Pub. No.: US 2014/0091943 A1
(43) Pub. Date: Apr. 3, 2014

(54) Telemetry System for Communications Between Surface Command Center and Tool String

(71) Applicants: Jorge Andres Herrera Duarte, Santiago de Cali (CO); Juan Sebastian Fernandez, Cali (CO)

(72) Inventors: Jorge Andres Herrera Duarte, Santiago de Cali (CO); Juan Sebastian Fernandez, Cali (CO)

(21) Appl. No.: 13/632,379

(22) Filed: Oct. 1, 2012

(51) Int. Cl. G01V 3/00

(52) U.S. Cl. 340/854.9

(57) ABSTRACT

A method is provided for transmitting data in a resource recovery operation featuring a borehole extending through a geologic formation, an uphole communications control center, and a downhole tool string, a method for transmitting data. The method includes (a) providing a first transceiver which is disposed in an uphole location, and a second transceiver which is in communication with the first transceiver and which is disposed in a downhole location; and (b) transmitting a signal from one of the first and second transceivers to the other of the first and second transceivers, wherein the transmitted signal encodes data using a modified alternating mark (AMI) system in conjunction with balanced line coding.

### FIELD OF THE DISCLOSURE

The present disclosure relates generally to communications systems, and more particularly to telemetry systems which allow communication of data between a command center and a tool string in a subterranean well.

### BACKGROUND OF THE DISCLOSURE

Common downhole operations in oil and natural gas exploration, such as the drilling of boreholes, or the use of ultrasonic tools to evaluate cement bonding and pipe conditions within a well, require an effective communication system for transmitting data between the surface command center and the remote tools disposed in the tool string at the bottom of the well. In particular, these operations typically involve acquiring information at the command center from sensors in the remote tools, and sending operating instructions from the command center to the tool string. At present, these communications are handled through telemetry systems, which also serve to provide power through the logging cable.

In order to operate at optimal effectiveness, telemetry systems need to be able to accurately transmit high data throughputs. For example, in order to drill boreholes successfully and efficiently, it is important for the command center to be able to acquire detailed, continuous and accurate information about the geologic formations that are being drilled.

One common tool used to gain information about geologic formations during drilling is resistivity imaging. In this type of imaging, the resistivity of a formation is measured as a function of the depth of the borehole and the angle around the borehole.

Variations in the resistivity may then be plotted or displayed to provide an image of the geologic formation penetrated by the borehole.

In a technique referred to as logging-while-drilling (LWD), resistivity imaging is performed by a resistivity logging tool that is disposed in a bottomhole assembly. The bottomhole assembly generally includes a drill bit located at the distal end of a drill string. As the borehole is being drilled, resistivity images are obtained and transmitted to the surface command center during the drilling process. At the command center, the resistivity images may be recorded, displayed and analyzed for appropriate action.

### BRIEF DESCRIPTION OF THE DRAWINGS

FIG. 1 is an illustration of a resource recovery operation in which the systems and methodologies of the present disclosure may be utilized.

FIG. 2 is an enlarged view of the downhole tool of FIG. 1.

FIG. 3 is an illustration of the construction of conventional monocable.

FIG. 4 is a functional illustration of the system of FIG. 1.

FIG. 5 is an illustration showing the effect of the signal processing implemented by the embodiment of FIG. 4.

FIG. 6 is an illustration of signal distortion and attenuation; the upper portion of the figure shows the signal at uplink, and the lower portion of the figure shows the signal after transmission over a 20,000 ft cable.

FIG. 7 is an illustration of signal distortion and attenuation; the upper portion of the figure shows the signal at uplink, and the lower portion of the figure shows the signal after transmission over a 20,000 ft cable.

FIG. 8 is an illustration of the downhole telemetry architecture of the system of FIG. 4.

FIG. 9 is an illustration of the uphole telemetry architecture of the system of FIG. 4.

FIG. 10 is an illustration showing the effect on signal distortion and attenuation of the signal processing methodology implemented by the system of FIG. 4.

FIG. 11 is an illustration of the line coding of a typical B2M2C signal.

FIG. 12 is an illustration of a preferred embodiment of the line coding of the transmission process implemented by the system of FIG. 4.

FIGS. 13-14 illustrate a preferred embodiment of the signal recovery process implemented by the system of FIG. 4.

FIG. 15 is a flowchart of a preferred embodiment of the decodification routine used for uphole and downhole systems in the systems and methodologies described herein.

FIG. 16 is a flowchart of a preferred embodiment of the transmission routine used for uphole and downhole systems in the systems and methodologies described herein.

FIG. 17 is an illustration of a conventional non-return-to-zero (NRZ) signal.

FIG. 18 is an illustration of an uphole receiver and equalizer architecture.

### SUMMARY OF THE DISCLOSURE

In one aspect, a method is provided for transmitting data in a resource recovery operation featuring a borehole extending through a geologic formation, an uphole communications control center, and a downhole tool string, a method for transmitting data. The method comprises (a) providing a first transceiver which is disposed in an uphole location, and a second transceiver which is in communication with the first transceiver and which is disposed in a downhole location; and (b) transmitting a signal from one of the first and second transceivers to the other of the first and second transceivers, wherein the transmitted signal encodes data using a modified alternating mark (AMI) system in conjunction with balanced line coding.

In another aspect, a method is provided for transmitting data in a resource recovery operation featuring a borehole extending through a geologic formation, an uphole communications control center, and a downhole tool string, a method for transmitting data. The method comprises (a) providing a first transceiver which is disposed in an uphole location, and a second transceiver which is in communication with the first transceiver and which is disposed in a downhole location; (b) receiving, at one of the first and second transceivers, a distorted version of a signal transmitted from the other of the first and second transceivers; (c) equalizing the received signal; (d) generating and synchronizing a clock with the timing of the received signal; and (e) producing a corrected signal from the equalized signal by forcing zeroes in those portions of the equalized signal that the synchronized clock indicates should be RZ zeroes.

### DETAILED DESCRIPTION

While LWD systems represent a notable improvement in the art, further improvements in these systems is required. Currently, the growing need for better reservoir description in the oil and natural gas industry has resulted in the use of new sensors which generate larger data files. These larger data files require larger telemetry capabilities in order for the remote tools in the tool string to effectively send the data back to the surface command center.

A similar problem is encountered with other downhole operations, such as the use of ultrasonic tools to evaluate cement bonding and pipe conditions within a well. These applications also require a high speed, large capacity telemetry system to send the large amount of information acquired to the surface, and further require that the telemetry system be capable of sending and receiving commands and data in full duplex or half duplex communication modes, and over mono-cable and multi-cable lines, in order to control tool parameters. There is also a need in the art for such a telemetry system to be an open system, thus allowing smaller service companies to effectively compete with larger ones.

In some applications, bipolar signals have been used in downhole telemetry to boost data transmission rates. Such applications frequently employ a monocable to transmit data between the surface command center and remote tools. However, in practice, the construction of the monocable is found to induce phase and amplitude distortion in signals transmitted between the surface command center and remote downhole tools. These distortions adversely affect the performance of the communication system, and typically increase with cable length.

Various signal processing algorithms have been developed to date in attempts to reduce the aforementioned distortions, but the signals processed by these algorithms still have significant amounts of distortions in them. Thus, while the use of monocables and bipolar signals improves data transmission rates in downhole telemetry applications, the distortions attendant to this approach adversely affect signal and image resolution. There thus exists a need in the art for systems and methodologies that provide for both higher data transmission rates and higher signal and image resolution.

It has now been found that the foregoing problems may be addressed through the use in a telemetry system of a special coding algorithm to balance the signal on the transmitter end. This coding algorithm may be used in conjunction with automatic signal gain control at the receiver end which is specific to each cable equalization algorithm. The recovered signal may be used by a surface computer to process, store, record and display the data from the remote sensors and downhole tools, which typically require very large data transmission rates. This approach may be used to provide higher data transmission rates and improved signal and image resolution with bipolar signals transmitted over monocable transmission lines. Thus, for example, using this approach, high resolution images and communications speeds of 130 Kbps may be attained, depending on the type and length of the lines.

It has further been found that higher data transmission and reception rates may be achieved or facilitated in such telemetry systems through the use of electronic array gates which operate at high internal high clock speeds and high temperatures. The use of such array gates may be combined with a special balanced RZ bipolar coding system described herein which optimizes the application of automatic gain control and equalization systems.

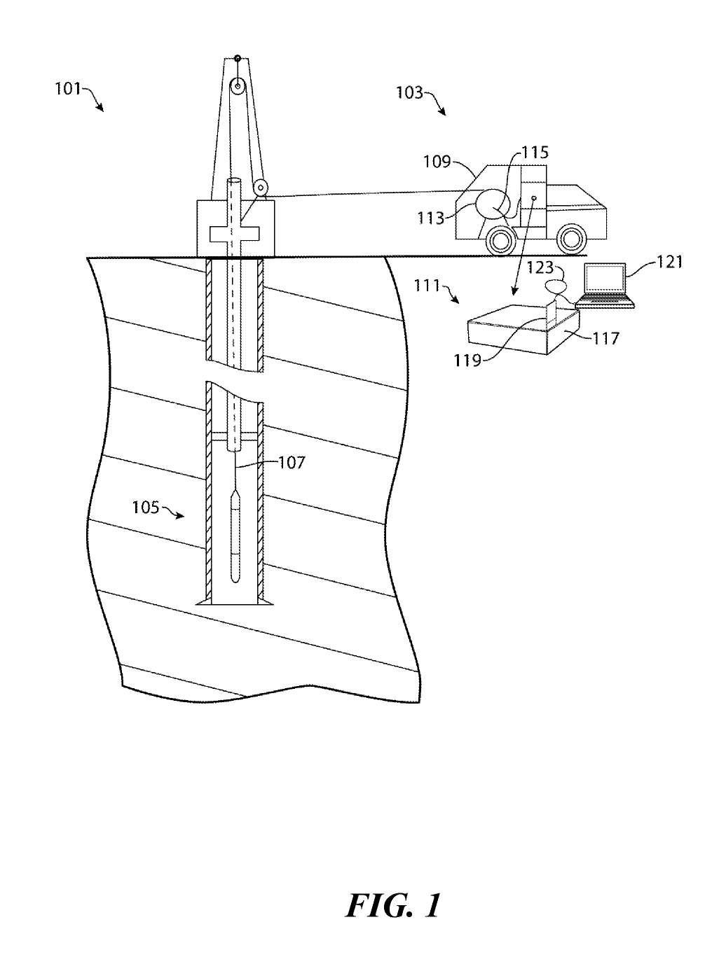

FIG. 1 illustrates a first particular, non-limiting embodiment of a telemetry system for communications between a surface command center and a tool string in accordance with the teachings herein. The system 101 depicted therein includes an uphole command center 103, a remote downhole tool 105, and a cable 107 which extends between the command center 103 and the tool 105.

The command center 103 is typically a ground-based structure or vehicle which houses a communications system that provides commands to, and receives data from, the downhole tool 105. The communications control center 103 typically includes a cabin 109 which houses a data processing system 111, a cable drum 113 which holds spools of additional cable, and an interconnecting special cable 115 which connects the portion of cable 107 spooled in the cable drum 113 to the data processing system 111.

The data processing system 111 includes an interface power and acquisition panel 117, a communications module 119 (which is typically located in the logging unit for oil field applications), an interface computer 121 which runs the logging software and which serves as the user interface for the operator/engineer, and a USB cable 123 or other suitable cable for connecting the interface computer 121 to the communications module 119.

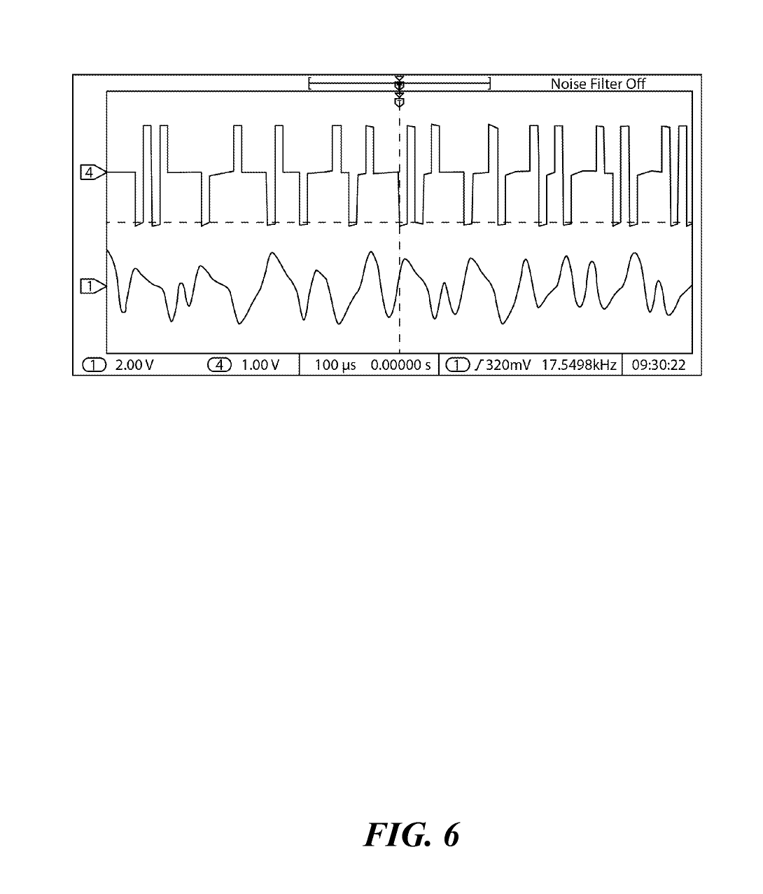

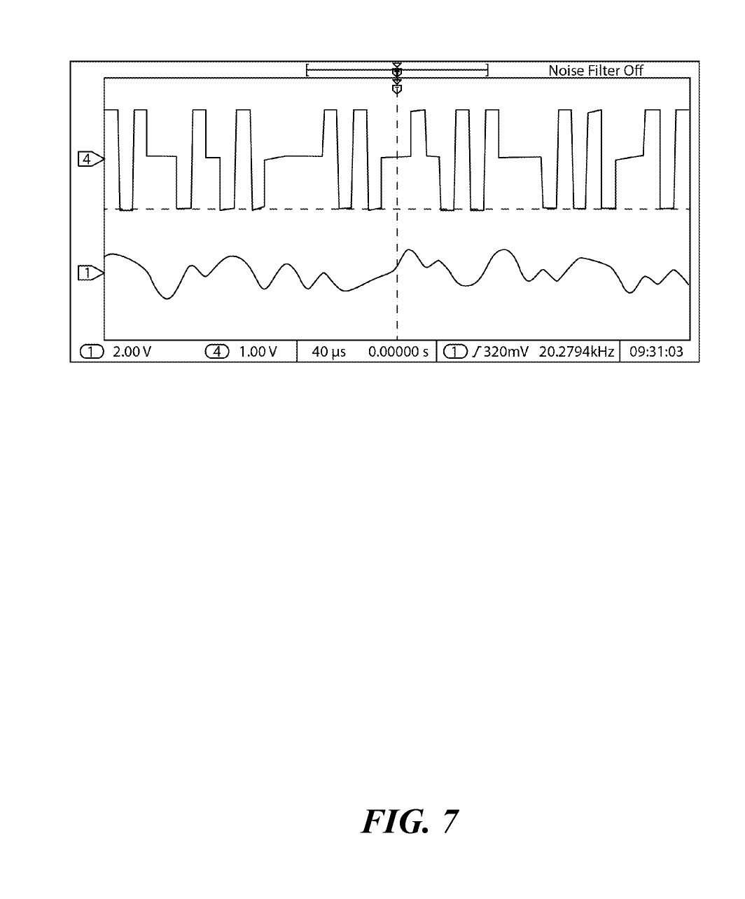

The communications module 119 includes a transceiver which is in communication with the interface computer 121. The transceiver receives the distorted and attenuated signal (see, e.g., FIGS. 6-7) from remote downhole tool 105 and, through a process described in greater detail below, recovers the original information encoded in the signal. This information is then routed to the interface computer 121 for further processing.

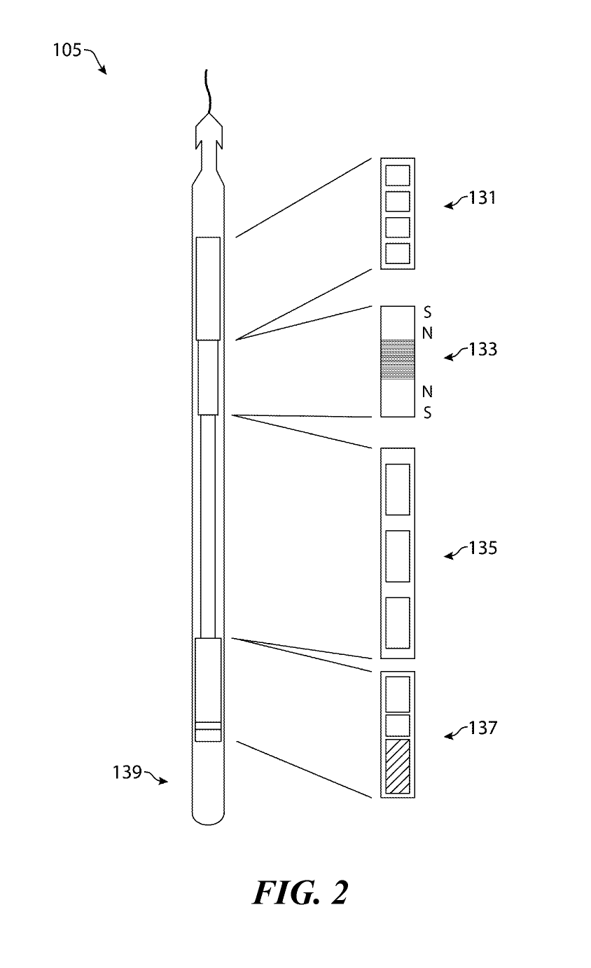

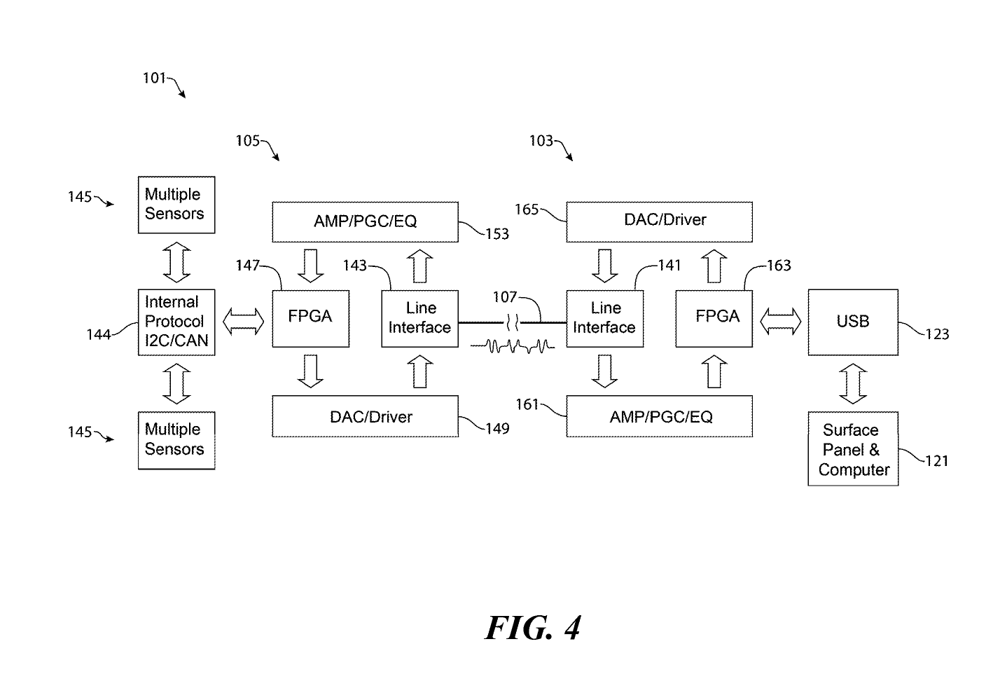

With reference to FIG. 2, the downhole tool 105 preferably comprises a transceiver (element 143 in FIG. 4) and associated electronics to power sensor measurements. The downhole tool 105 is often packed inside a cylindrical steel housing 151 that protects the electronics components of the module and allows deployment in hostile conditions. Such conditions may include, for example, pressures up to 18,000 psi and temperatures as high as 350° F. The downhole tool 105 preferably includes five main components, including a short regulator module 131, a casing collar locator module 133, a telemetry and communications electronics module 135, a gamma ray module 137 and additional sensor modules 139. Each of these components is described in greater detail below.

The shunt regulator module 131 manages excess power fluctuations. It contains a shunt regulator and one or more photomultipliers, and is used for detecting thermal (slow) neutrons for formation porosity measurements (e.g., for identifying possible areas in the formation which contain oil or gas).

The casing collar locator module 133 contains a series of magnets, and is used to locate casing joints by detecting the additional metal thickness present at such joints. This information may be used, for example, to count the overall number and length of casing joints the tool has passed, thus allowing the operator to accurately determine the depth of the tool.

The telemetry and communications electronics module 135 includes power supply electronics, an internal remote transceiver unit (RTU) (element 143 in FIG. 4), filters and other electronics. The telemetry and communications electronics module 135 receives commands from the command center 103 and transmits data to the command center 103 from the downhole tool 105 and its sensors and components.

The gamma ray module 137 typically includes a special high voltage power supply, a photomultiplier, amplifiers, and a special crystal for gamma ray detection. The gamma ray module 137 may be used to measure naturally occurring gamma radiation for the purpose of characterizing rock or sediment in a borehole. Thus, for example, the gamma ray module 137 may be used to distinguish between shales and non-shales (e.g., sandstones or carbonate rocks) in a formation by virtue of the differences in natural radioactivity of these materials due to the presence of thorium, uranium and radioactive potassium.

The additional sensor modules 139 may be of various types, and may be dictated, for example, by the particular site or application. These modules are typically connected in tandem, and maintain communication with the uphole command center 103 via the RTU (see element 143 in FIG. 4) in the telemetry and communications electronics module 135.

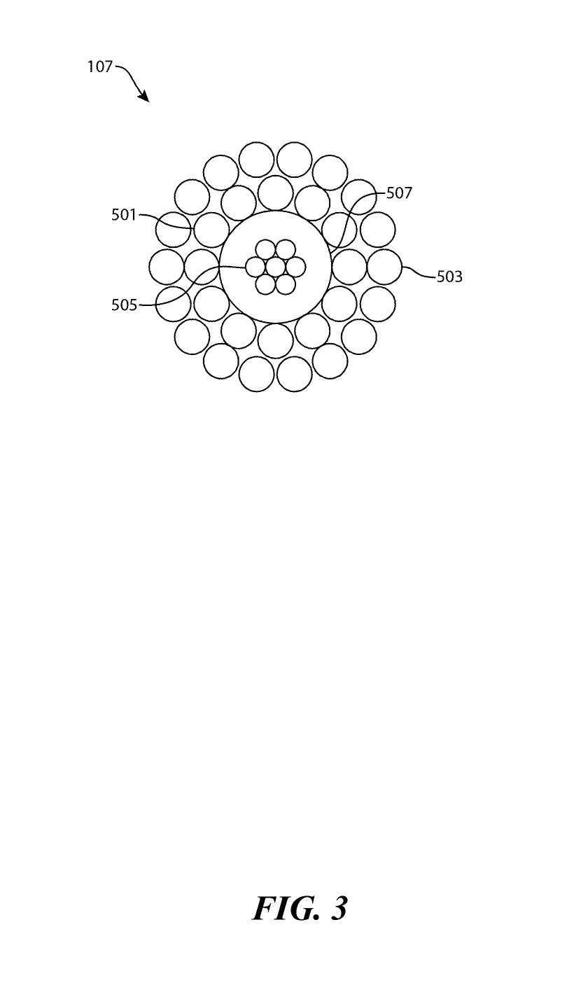

FIG. 3 depicts a preferred embodiment of the communications cable 107 used in the system 101 of FIG. 1. As seen therein, the communications cable 107 preferably comprises first 501 and second 503 multiple-strand layers and at least one inner conductor 505 which is electrically and/or thermally isolated from the first 501 and second 503 multiple-strand layers by a suitable cover layer 507. Preferably, the at least one inner conductor 505 comprises copper, the first 501 and second 503 multiple-strand layers comprise steel, and the cover layer 507 comprises polytetrafluoroethylene such as that marketed under the trade name Teflon®. The first 501 and second 503 multiple-strand layers are typically coaxially wound in opposite directions so that a twist that opens one of these layers will tighten the other layer. The first 501 and second 503 multiple-strand layers protect the inner conductor 505 from damage, and also provide pulling capabilities for the deployment and retrieval of the remote tool 105.

FIG. 4 is a functional illustration of the system of FIG. 1, and depicts the interaction between the uphole command center 103 (and the associated uphole transceiver 141) and the downhole tool 105 (and the associated downhole transceiver 143). The uphole 141 and downhole 143 transceivers provide bidirectional communications in half duplex mode between the command center 103 and the tool 105. This mode of operation allows the command center 103 to control the remote tool 105 and its associated sensors 145 by sending appropriate operating instructions to the tool 105 via a communications link (in this embodiment, cable 107) between the uphole 141 and downhole 143 transceivers. Similarly, this mode of operation also allows the command center 103 to acquire information from the remote tool 105 and its associated sensors 145 via the cable 107 extending between the uphole 141 and downhole 143 transceivers, and to process this information at the computer 121 and its associated logging panel.

The remote sensors 145 communicate to the downhole transceiver 143 via an internal protocol 144. The tool 105 includes a FPGA (Field-Programmable Gate Array) 147 with hardware and firmware embedded therein which is typically proprietary. The FPGA 147 encodes data that is going to the digital-to-analog converter (DAC) 149, and finally to the cable 107 through the downhole transceiver 143.

The control commands from the command center 103 are recovered by the amplifier/programmable gain control/equalizer (AMP/PGC/EQ) modules 153 in the downhole tool 105. The signal received by the command center 103 from the downhole transceiver 143 via the cable 107 is attenuated and distorted, and is recovered following a process similar to that employed by the downhole transceiver 141 to recover the signal received from the command center 103.

The uphole transceiver 141 has special amplifier, equalization modules and programmable gain control circuits (AMP/PGC/EQ) 161 that allow the recovery of the distorted signal received from the downhole transceiver 143. The main control via the FPGA 163 has hardware and software that is typically special and proprietary. Once the signal is recovered by the uphole transceiver 141, it is sent to the computer 121 in the uphole communications control center 103 via a USB port 123 to recover the encoded data and information and to allow control of the remote downhole tool 105 by the operator/engineer at the surface.

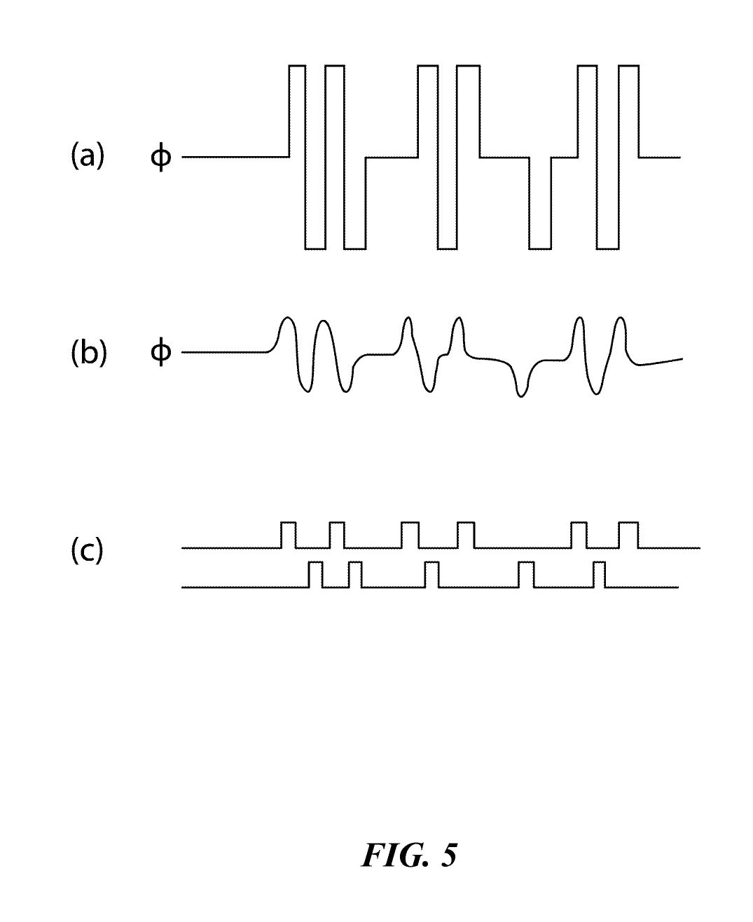

FIG. 5 shows the transformations the signal goes through from its original form (at uplink) to its final (recovered) form. Thus, FIG. 5(a) shows the original uplinked signal, which has been coded using a Binary Balanced Modified Manchester Code (B2M2C) to ensure proper return to zero. FIG. 5(b) shows the signal after it has been recovered through processing by the equalizer and AGC modules, and FIG. 5(c) shows the final recovered digital signal. The manner in which the signal is recovered is described in greater detail below.

The distortion and attenuation which can occur in the signal as a result of transmission through the cable may be appreciated with reference to the two signal samples shown in FIGS. 6 and 7. Each sample shows the original signal at uplink (top of diagram) and the signal after transmission over 20,000 ft of monocable (bottom of diagram). It will be appreciated from these figures that the received signal requires considerable processing in order to accurately recover the data encoded therein.

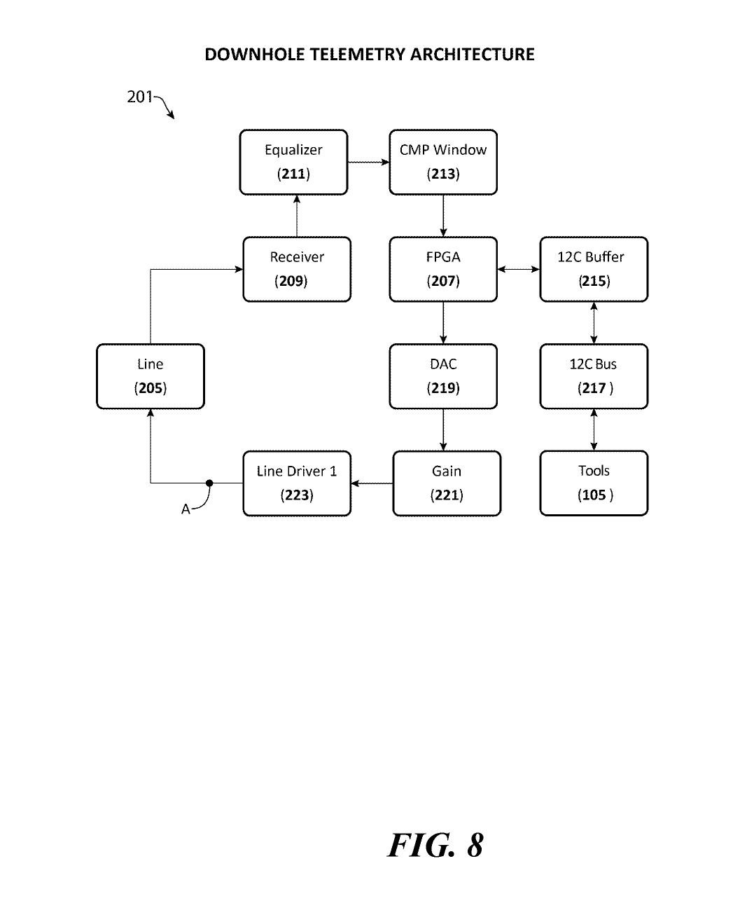

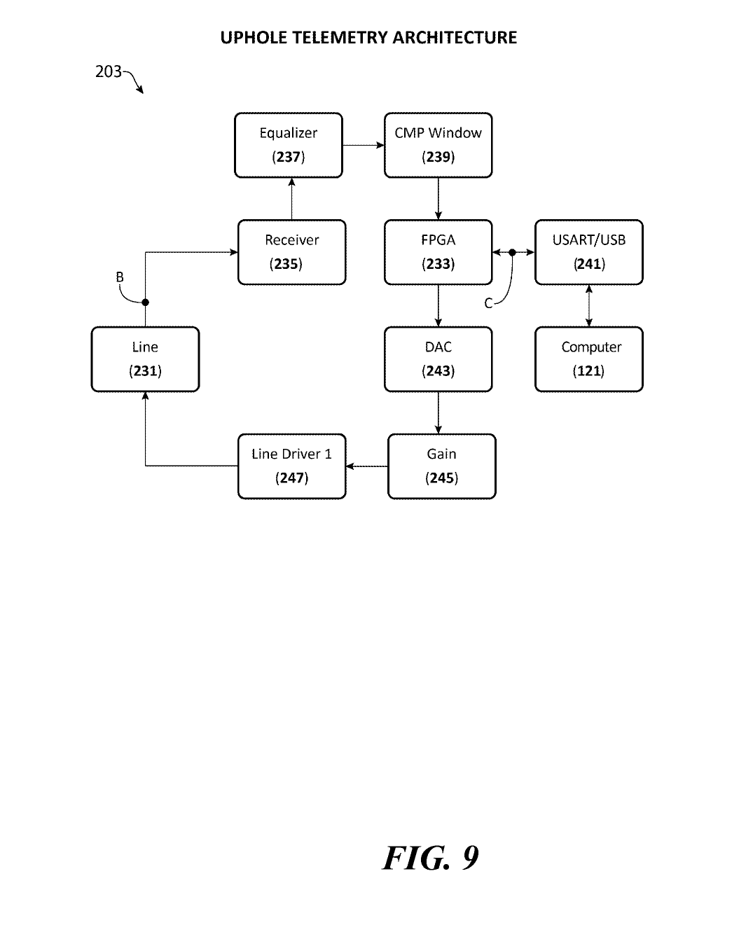

FIGS. 8 and 9 depict, respectively, the telemetry architectures of the downhole 201 and uphole 203 portions of the system 101 depicted in FIG. 1. With reference to FIG. 8, the downhole 201 portion of the system 101 comprises a line 205, which is simply a first portion of the cable 107 in FIG. 1. A field programmable gate array 207 (FPGA) receives signals from the line 205 via a receiver 209, an equalizer 211 and a CMP window 213, and communicates commands to the tool 105 via a 12 C buffer 215 and a 12 C bus 217. The FPGA 207 receives data from the tool 105 and communicates the data to the line 205 via a digital-to-analog converter (DAC) 219, gain 221 and line driver 223.

With reference to FIG. 9, the uphole 203 portion of the system 101 depicted in FIG. 1 comprises a line 231, which is simply a second portion of cable 107 in FIG. 1. A field programmable gate array 233 (FPGA) receives signals from the line 231 via a receiver 235, an equalizer 237 and a CMP window 239, and communicates these signals (which encode data received from the remote tool 105; see FIG. 8) to the computer 121 (see FIG. 1) via a USB to serial Universal Synchronous and Asynchronous serial Receiver and Transmitter (USART) interface 241. The FPGA 233 receives commands from the computer 121 and communicates these commands to the line 231 via a digital-to-analog converter (DAC) 243, gain 245 and line driver 247.

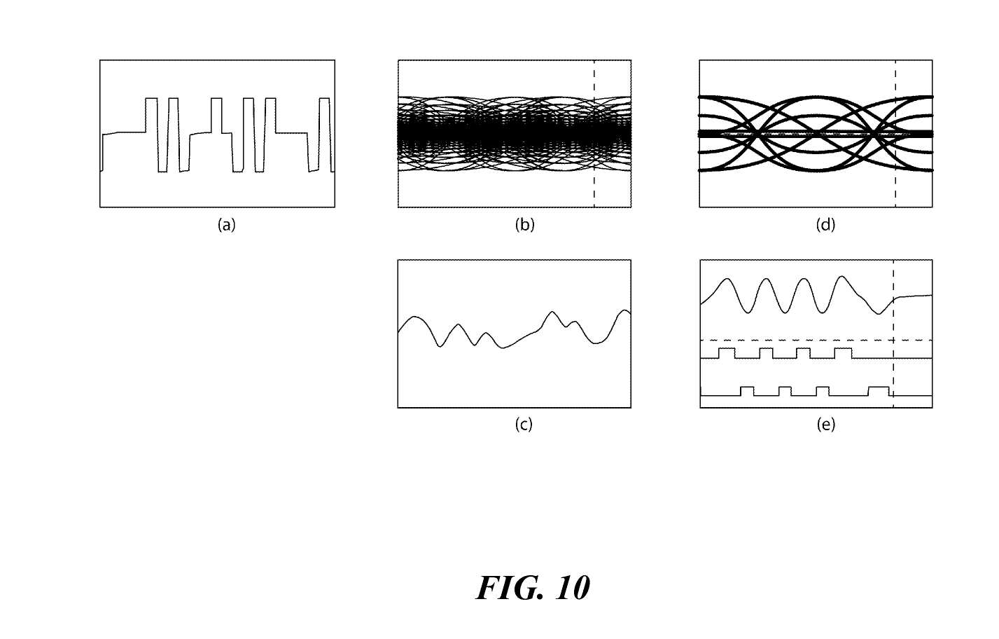

The effectiveness of the telemetry system depicted in FIG. 6 may be appreciated with respect to FIG. 10. As seen in FIG. 10a, the transmitted signal (obtained at POINT A in FIG. 8) is sharp and undistorted at uplink. FIG. 10b shows an eye diagram of the signal as received by the uphole transceiver (obtained at POINT B in FIG. 9), and FIG. 10c shows the associated signal sequence for the eye diagram of FIG. 10b. FIG. 10d shows an eye diagram of the recovered signal after application of the equalized intelligent subtraction and model matching process described herein (obtained at POINT C in FIG. 9), and FIG. 10e shows the associated de-codification patterns of the recovered signal. As seen therein, the signal has been accurately recovered by the uphole transceiver using the methodologies described herein.

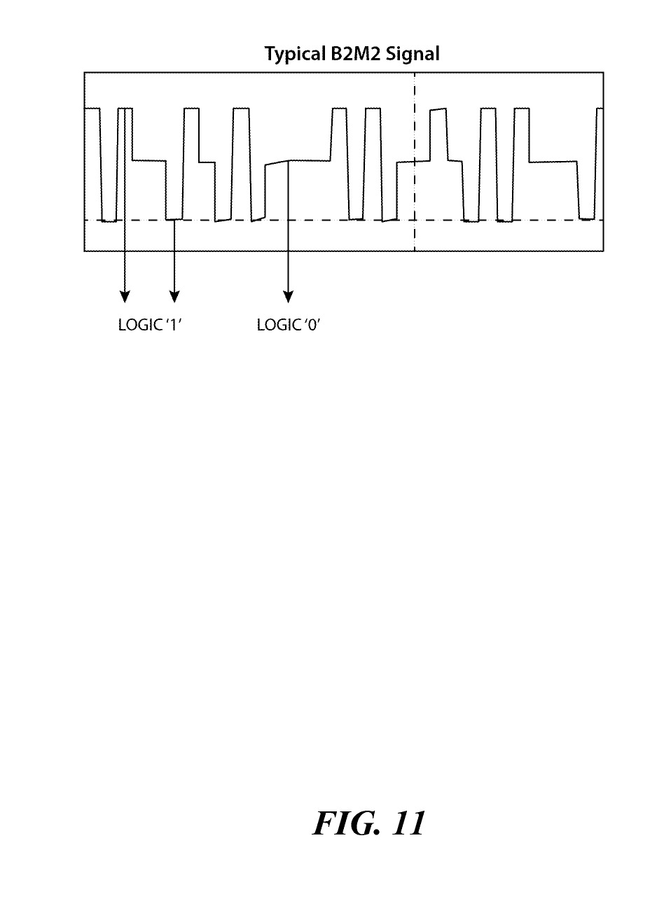

FIGS. 11-13 illustrate the preferred embodiment of the line coding methodology employed in the systems and methodologies described herein.

FIG. 11 illustrates a binary balanced modified Manchester code (B2M2C code) of the type utilized herein. The B2M2C code combines the well-studied and published Modified Alternating Mark (AMI) system (invented for data transmission through large transmission lines) with an intelligent decoding system that maintains the binary transmission in the line balanced around a zero DC level.

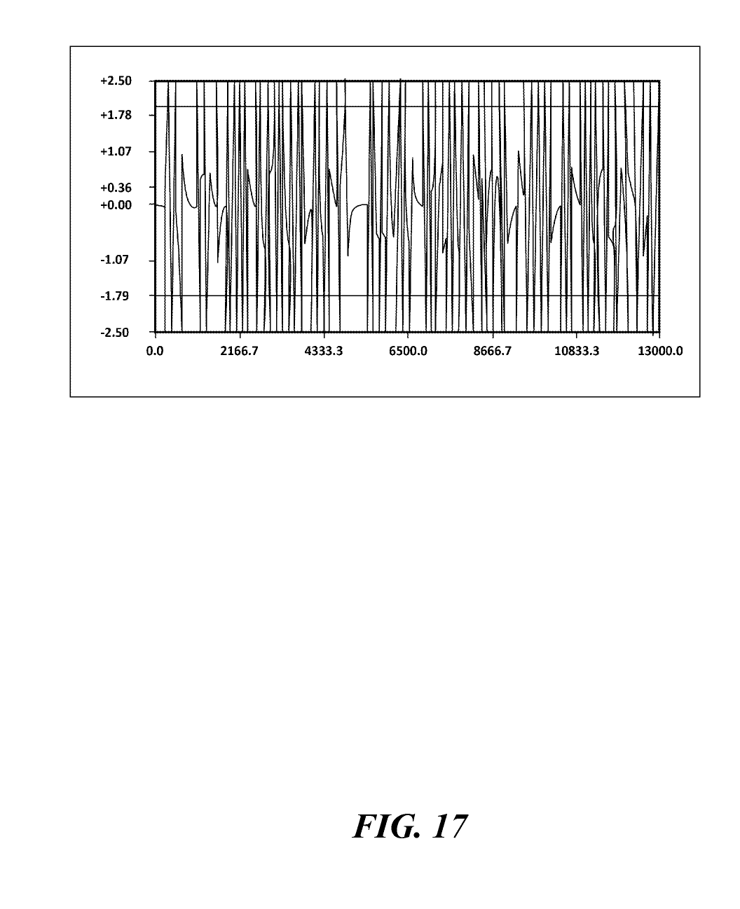

At present, most telemetry systems currently in use are multi-level and multi-frequency band systems based on non-return-to-zero (NRZ). NRZ is a binary code in which 1's are represented by a first significant condition (usually a positive voltage) and 0s are represented by a second significant condition (usually a negative voltage), with no other neutral or rest condition. Hence, NRZ does not have a rest state. An example of a signal in such a system is depicted in FIG. 17.

In contrast to such a system, the B2M2C, two-way communicating system described herein guarantees that transitions are always present before and after each mark (1 bit), but are missing between adjacent spaces (0 bits). This approach maintains the DC level offset close to zero (balanced line coding), which allows the application of intelligent signal filtering and equalization in hardware and software based initially on the well known wireline characteristics provided by the cable manufacturers. Further refinement or adoption of the intelligent filtering models described herein may allow equalization in other special conditions.

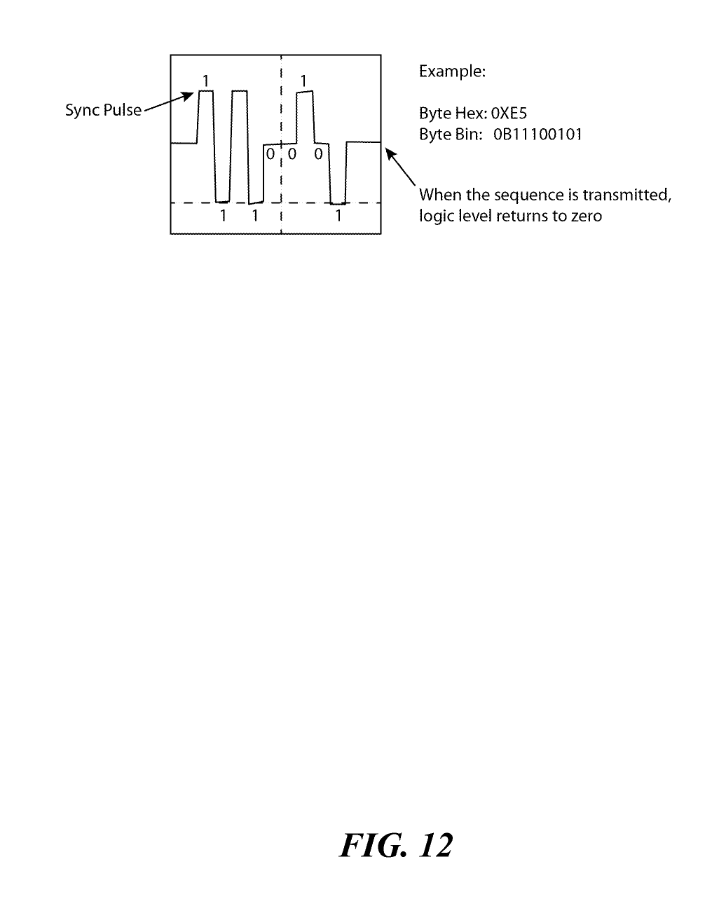

With respect to FIG. 12, in the preferred embodiment, the digital encoding and transmission process described herein takes a single byte and transmits bit per bit from least significant bit (LSB) to most significant bit (MSB) up to 100 kbps using modified alternate mark inversion (AMI) line codes. Each transmitted sequence of bytes (that is, each data frame) is preceded by a synchronization pulse.

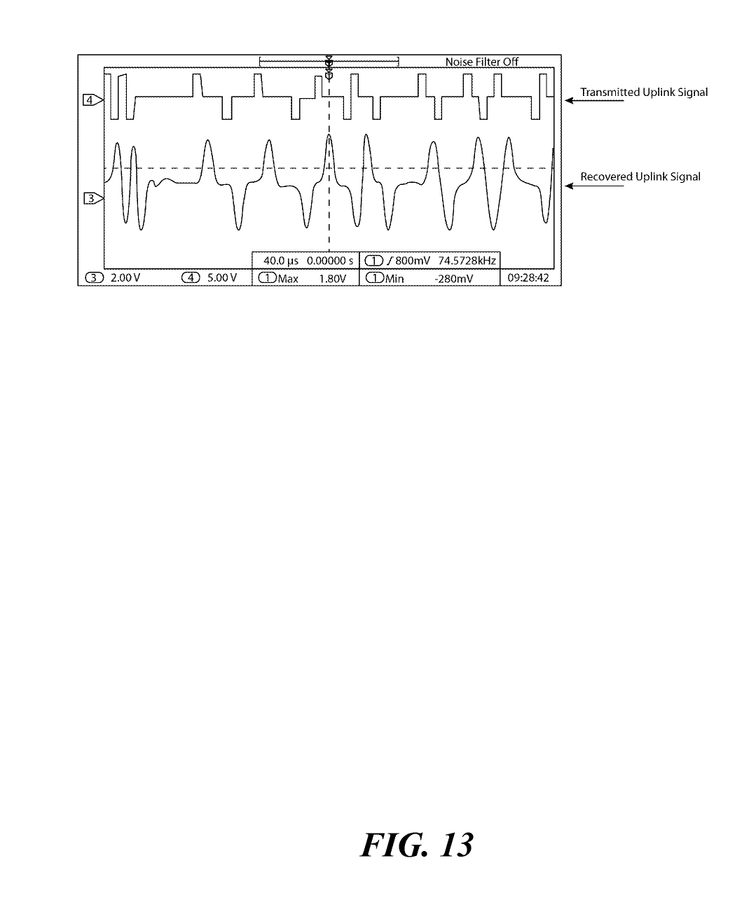

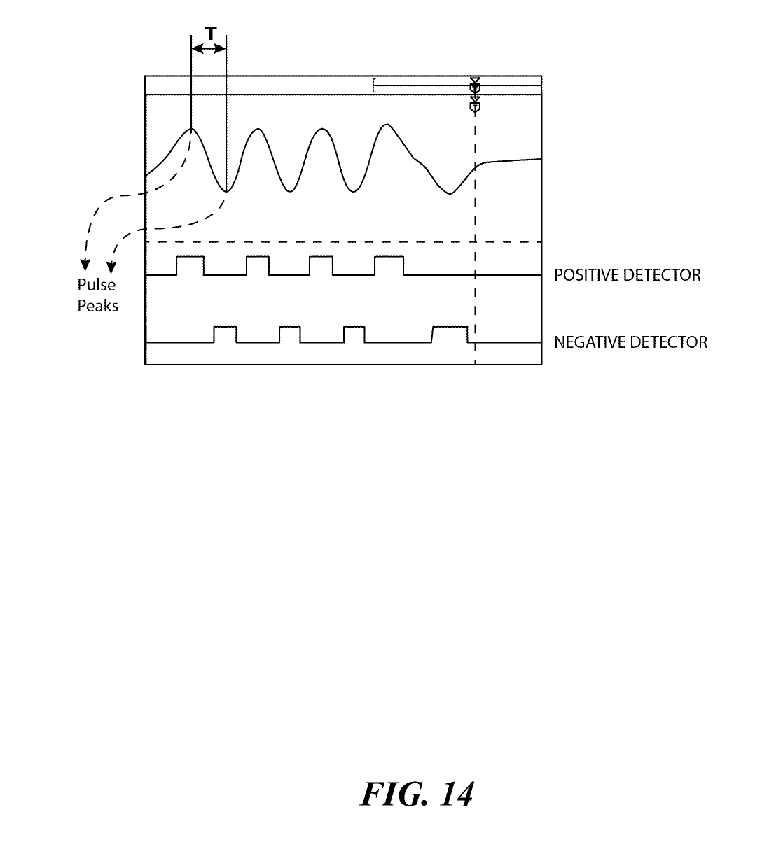

FIGS. 13-14 illustrate the signal recovery process. As seen in FIG. 13, the decoder process always remains on standby while not receiving pulses. Once a pulse is received (the start pulse), the de-codification process begins running Since it is not possible to recover the received signal exactly as it was transmitted, the de-codification algorithm has special features to recover the encoded data.

As part of the decoding process, the time distance between each pulse peak is calculated, and the number of zeros between logic ones is determined. The period of the transmitted signal is known, based on the line model parameters as shown in FIG. 14. Using this approach, every time that a rising edge (a positive edge event) is detected on the outputs of the comparators, a logic one is assigned to the DATA_BUFFER and starts the pulse counter width. Then, the process waits until the negative edge is detected (a negative edge event), and stops the pulse counter width. The time reference is then assigned as Counter Width÷2, and for each transmission period completed, the system assigns a logic zero to the data buffer until a new positive edge is detected. At this point, the system restarts the process.

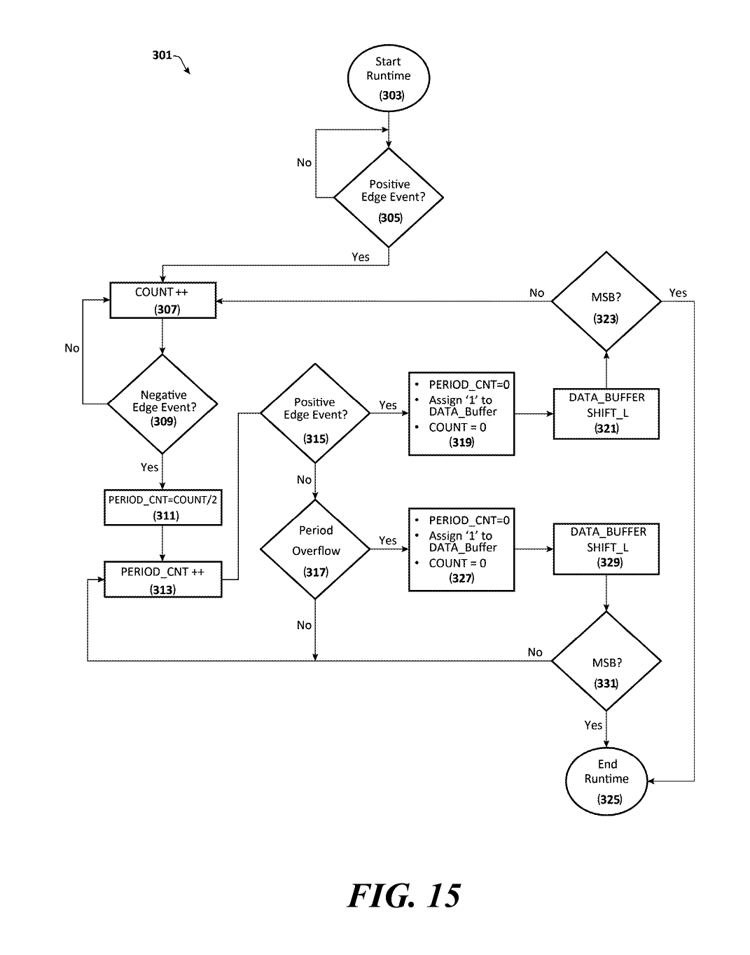

The foregoing de-codification algorithm, which may be used in both the uphole and downhole systems, is depicted in the flowchart of FIG. 15. After the process 301 depicted therein commences 303, the decoder remains in a standby loop whose exit condition is the detection of a positive edge event 305 (that is, the standby loop continues so long as the Boolean variable Positive Edge Event is false, and terminates when this variable is true). When such an event is detected, a counter (whose value is stored in the integer variable COUNT) is incremented 307 until a negative edge event 309 is detected (that is, until the boolean variable Negative Edge Event is true), at which time the period of the signal (assigned to the variable PERIOD_CNT) is assigned the value of COUNT/2 311. The variable PERIOD_CNT is then incremented 313, after which the process enters a loop in which the variable PERIOD_CNT is further incremented 313 until either a positive edge event 315 occurs or a PERIOD overflow event 317 occurs.

If a positive edge event 315 occurs, then the variable PERIOD_CNT is set to 0, a “1” is assigned to the data buffer, and the value of the variable COUNT is set to 0 319. The data buffer then shifts one bit to the left 321. If the current bit is the MSB 323, then the process terminates 325. Otherwise, the process returns to the counting loop, the exit of which is contingent on the occurrence of a negative edge event 309.

If a PERIOD overflow event occurs 317, then the variable PERIOD_CNT is set to 0, a “0” is assigned to the data buffer, and the value of the variable COUNT is set to 0 327. The data buffer then shifts one bit to the left 329. If the current bit is the MSB 331, then the process terminates 325. Otherwise, the process returns to the counting loop, the exit of which is contingent on the occurrence of a negative edge event 309.

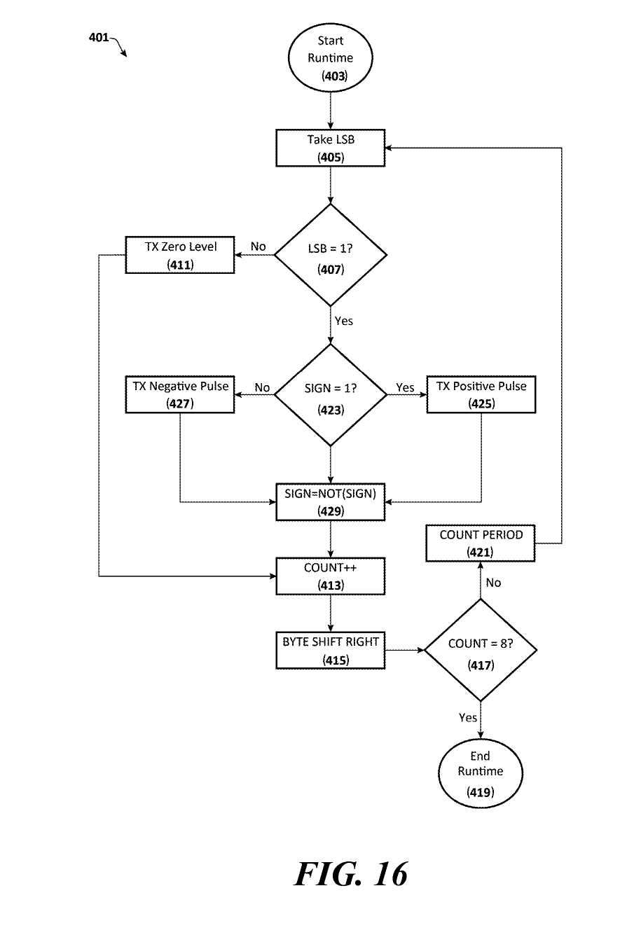

The preferred embodiment for the transmission routine for the uphole and downhole transceivers and systems may be appreciated with respect to the flowchart of FIG. 16. As seen therein, when the routine 401 commences 403, the least significant bit (LSB) is determined 405.

The LSB is then compared to 1 407; if it is not 1, then the transmission is at a 0 level 411. A counter variable is incremented by 1 413, and the register shifts by one byte to the right 415. If the boolean variable that represents the condition that the counter variable has the value 8 417 (that is, the condition that COUNT=8) is true, then the process has reached the end of the byte, and the process terminates 419; if this variable is false, then the period is counted 421, and the process loops back to determining the LSB 405.

If the LSB is 1, then the determination is made 423 as to whether the sign of the bit is equal to 1. In particular, the determination is made whether the condition of the variable SIGN=1 is true or false. If this condition is true, then the transmission is a positive pulse 425; if not, then the transmission is a negative pulse 427. The value of the variable SIGN is then reversed 429, the process passes to incrementing the counter by 1 413, and the register is shifted by one byte to the right 415.

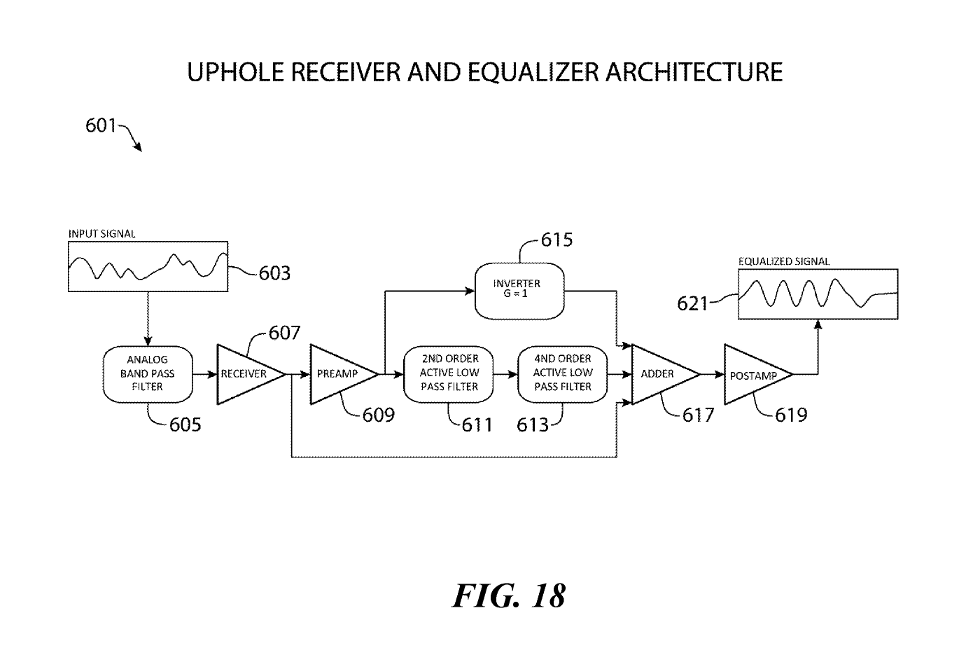

FIG. 18 is an illustration of the uphole receiver and equalizer architecture which may be utilized in the systems and methodologies described herein. The uphole equalizer 601 is a bandpass filter with various stages. At input 603, the signal coming from line is “prefiltered” using an analog bandpass filter 605. The signal then passes through a buffer receiver 607 with fixed gain. Then signal is then pre-amplified using a PGO (Programmable Gain Operational amplifier) or PreAmp 609.

Next, the output from the PreAmp 609 is filtered in two stages. In the first stage, the signal is processed with a 2^{nd} order active low pass filter 611 which has a fixed cut off frequency. In the second stage, the signal is processed with a 4^{th} order active low pass filter 613 with a programmable cut off frequency. In parallel, the output from the PreAmp 609 is passed through an inverter 615.

The next block in the equalizer architecture is an adder 617. The adder 617 sums the (i) receiver 607 output, (ii) the inverter 615 output, and (iii) the 4^{th} order active low pass filter 613 output. The gain of these three signals in the adder 617 is programmable using digital resistors. Finally, the adder 617 output is amplified by a post amplifier (PostAmp) 619 which is also a PGO. The output of the PostAmp 619 is the restored, equalized signal 621 coming from the downhole telemetry system (see FIGS. 4 and 9).

As previously noted, the systems and methodologies described herein provide for two-way communication between first and second transceivers (such as an uphole transceiver and a downhole transceiver) utilizing transmitted signals. The signals, which are typically binary signals, preferably encode data using a modified alternating mark (AMI) system in conjunction with balanced line coding. The algorithm used to decode the received signal preferably balances the transmission in the line around a zero DC level. Preferably, the transmitted signal has transitions before and after each mark such that the transitions are missing between adjacent spaces (0 bits), and such that the DC level offset is maintained close to zero.

One skilled in the art will appreciate that appropriate clocks may be used to implement signal processing in the systems and methodologies described herein. For example, in some embodiments, when a distorted signal is received at a transceiver, it may be equalized. A clock may then be generated and synchronized with the timing of the received signal, and a corrected signal may be produced from the equalized signal by forcing zeros in those portions of the equalized signal that the clock indicates should be RZ (return-to-zero) zeros. In particular, the pulses and spaces in the equalized signal may be detected, and a corrected signal may be produced from the equalized signal by forcing zeros in those portions of the equalized signal that the synchronized clock indicates should be RZ zeros.

As noted above, equalization is preferably accomplished using the process and architecture depicted in FIG. 18. During equalization, one or more time intervals may be calculated based on the equalized signal and the corrected signal. These time intervals may then be utilized to calculate timing errors, and the equalizer switch values may be updated based on the calculated timing errors. The equalization step may involve linear equalization and/or decision feedback equalization. The equalization step preferably uses a least-mean-square (LMS) algorithm or a recursive least squares (RLS) algorithm for adapting tap values.

Various additional steps may be performed prior to, or during, equalization. For example, in some embodiments, a DC offset may be estimated from the equalized signal and the corrected signal, and the estimated DC offset may then be removed from the signal prior to equalizing it. Moreover, in some embodiments, the timing error may be saturated to a predetermined maximum value before updating the equalizer tap values based on that timing error.

In some embodiments, the received signal may be digitized via an analog-to-digital converter prior to equalizing the signal. In such embodiments, the timing of the analog-to-digital converter may be adjusted based on the group delay indicated by the updated tap values. The time constant selected for adjusting the timing of the digital-to-analog converter is preferably significantly different from the time constant utilized in the equalization step. These time constants may be selected so that adaptation through the equalization step is significantly faster than adaptation through adjusting the timing of the analog-to-digital converter. The output of the analog-to-digital converter may be monitored and, after a signal is detected from the converter, the equalization step may be enabled on the first incoming “1” or “−1” symbol.

In embodiments where the received signal is digitized, the received signal may be amplified through a variable gain amplifier prior to being digitized. A control word may be selected for the variable gain amplifier to maximize the quantization bit resolution for the analog-to-digital converter and to maintain the output of the analog-to-digital converter within an optimal range.

One skilled in the art will also appreciate that suitable interpolation algorithms may be utilized during signal processing in the systems and methodologies described herein. For example, as noted above, the equalized signal may be corrected by detecting pulses and spaces in the equalized signal, and then forcing zeros in those portions of the equalized signal that the synchronized clock indicates should be RZ zeros. However, prior to detecting these pulses and spaces, the equalized signal may be interpolated to produce a plurality of interpolated signals. This interpolation may be performed, for example, by using an appropriate polynomial phase filter amplifier.

Each of the plurality of interpolated signals may then be compared against a threshold value. The threshold value may be set, for example, based on the measured stability of the equalized signal. A signal may then be output that has (i) a “1” symbol for each portion of the interpolated signal that is positive and has an amplitude exceeding the threshold value, (ii) a “−1” symbol for each portion of the interpolated signal that is negative and has an amplitude exceeding the threshold value, and (iii) a “0” symbol otherwise. The plurality of output signals may then be combined into a single signal that includes all of the “1” or “−1” symbols which correspond to pulses in any of the interpolated signals. The steps of detecting the pulses and spaces, and of correcting the equalized signal, may then be performed on this combined output signal.

The step of comparing the interpolated signals against a threshold value may be implemented in a variety of ways. During periods when the equalized signal is stable, it is preferred that the comparing step proceeds in a constant mode in which the threshold value is set to, and remains at, a constant value. During periods when the equalized signal is not stable, it is preferred that the comparing step proceeds in a tracking mode in which the threshold value is adjusted regularly to track the unstable signal. This tracking mode may switch to the constant mode when the peaks detected in the equalized signal exceed a predetermined threshold level. Similarly, the constant mode may switch to the tracking mode when the peaks fall below a predetermined threshold level.

The steps of detecting the pulses and spaces, and of correcting the equalized signal, may be implemented in a variety of ways. For example, if the received signal is an RZ signal, the detecting and correcting step (or steps) may include (a) passing the equalized signal through a buffer; (b) detecting misplaced pulses and double pulses based on both the synchronized clock and the coding in the RZ signal; and (c) correcting the equalized signal. Correction of the equalized signal may involve moving the misplaced pulse or doubled portion of the pulse forward or backward in time. Equalized signal correction may also involve moving or zero asserting the samples of the equalized signal in the buffer to obtain a modified buffer, and outputting the results of the modified buffer.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

What is claimed is:

1. In a resource recovery operation featuring a borehole extending through a geologic formation, an uphole communications control center, and a downhole tool string, a method for transmitting data, comprising:
providing a first transceiver which is disposed in an uphole location, and a second transceiver which is in communication with the first transceiver via a cable and which is disposed in a downhole location; and
transmitting a signal from one of the first and second transceivers to the other of the first and second transceivers, wherein the transmitted signal encodes data using a modified alternating mark (AMI) system in conjunction with balanced line coding.

2. The method of claim 1, wherein the first and second transceiver are in two-way communication.

3. The method of claim 1, further comprising:
decoding the received signal using an algorithm that balances the transmission in the line around a zero DC level.

4. The method of claim 1, wherein the transmitted signal is a binary signal.

5. The method of claim 1, wherein the transmitted signal has transitions before and after each mark.

6. The method of claim 5, wherein the transitions are missing between adjacent spaces (0 bits).

7. The method of claim 5, wherein the transitions are missing between adjacent spaces (0 bits), thereby maintaining the DC level offset close to zero.

8. In a resource recovery operation featuring a borehole extending through a geologic formation, an uphole communications control center, and a downhole tool string, a method for producing a corrected signal from a distorted signal, comprising:
providing a first transceiver which is disposed in an uphole location, and a second transceiver which is in communication via a cable with the first transceiver and which is disposed in a downhole location;
receiving, at one of the first and second transceivers, a distorted version of a signal transmitted from the other of the first and second transceivers;
equalizing the received signal;
generating and synchronizing a clock with the timing of the received signal; and
producing a corrected signal from the equalized signal by forcing zeroes in those portions of the equalized signal that the synchronized clock indicates should be RZ zeroes.

9. The method of claim 8, wherein the corrected signal is produced from the equalized signal by:
detecting pulses and spaces in the equalized signal; and
correcting the equalized signal by forcing zeroes in those portions of the equalized signal that the synchronized clock indicates should be RZ zeroes, to produce a corrected signal therefrom.

10. The method of claim 8, further comprising:
calculating a timing interval based on the equalized signal and the corrected signal; and
updating equalizer switch values based on the calculated timing error.

11. The method of claim 10, further comprising, prior to detecting pulses and spaces in the equalized signal:
interpolating the equalized signal to produce a plurality of interpolated signals;
comparing each of the plurality of interpolated signals against a threshold value and outputting a signal having: (i) a “1” symbol for each portion of the interpolated signal that is positive and has an amplitude exceeding the threshold value, (ii) a “−1” symbol for each portion of the interpolated signal that is negative and has an amplitude exceeding the threshold value, and (iii) a “0” symbol otherwise; and
combining the plurality of outputted signals into a single signal that includes all “1” or “−1” symbols corresponding to pulses in any of the interpolated signals, wherein the detecting and correcting step is performed on this combined output signal.

12. The method of claim 10, wherein the interpolation is performed using a polynomial phase filter amplifier.

13. A method as claimed in claim 12, further comprising, prior to detecting and correcting misplaced pulses and double pulses in the equalized signal, comparing the equalized signal against a threshold value and outputting a signal having: (a) a “1” symbol for each portion of the equalized signal that is positive and has an amplitude exceeding the threshold value, (b) a “−1” symbol for each portion of the equalized signal that is negative and has an amplitude exceeding the threshold value, and (c) a “0” symbol otherwise, and wherein the detecting and correcting step is performed on this output signal.

14. A method as claimed in claim 12 or claim 13, further comprising setting the threshold value based on the measured stability of the equalized signal.

15. A method as claimed in claim 14, wherein:
during periods when the equalized signal is stable, the comparing step proceeds in a constant mode where the threshold value is set to and remains at a constant value; and
during periods when the equalized signal is unstable, the comparing step proceeds in a tracking mode where the threshold value is adjusted regularly to track the unstable signal.

16. A method as claimed in claim 15 wherein the tracking mode switches to the constant mode when the peaks detected in the equalized signal exceed a predetermined high threshold level, and wherein the constant mode switches to the tracking mode when the peaks fall below a predetermined low threshold level.

17. A method as claimed in claim 11, wherein the received signal is a coded RZ signal, and wherein the detecting and correcting step further comprises: (a) passing the equalized signal through a buffer; (b) detecting misplaced pulses and double pulses based on both the synchronized clock and the coding in the RZ signal; and (c) correcting the equalized signal by moving the misplaced pulse or doubled portion of the pulse forward or backward in time, by moving or zero asserting the samples of the equalized signal in the buffer and outputting the results of the modified buffer.

18. A method as claimed in claim 11, wherein the equalizing step is a linear equalization.

19. A method as claimed in claim 11, wherein the equalizer step is a decision feedback equalization.

20. A method as claimed in claim 11, wherein the equalization step uses the least-mean-square algorithm for adapting tap values.

21. A method as claimed in claim 11, wherein the equalization step uses the RLS algorithm for adapting tap values.

22. A method as claimed in claim 11, further comprising: (a) estimating a DC offset based on the equalized signal and the corrected signal; and (b) removing the estimated DC offset from the received signal prior to equalizing it.

23. A method as claimed in claim 11, further comprising saturating the timing error to a predetermined maximum value before updating the equalizer tap values based on that timing error.

24. A method as claimed in claim 11, further comprising:
digitizing the received signal through an analog-to-digital converter prior to equalizing it; and
adjusting the timing of the analog-to-digital converter based on the group delay indicated by updated tap values.

25. A method as claimed in claim 24, wherein a time constant is selected for adjusting the timing of the analog-to-digital converter that is significantly different from the time constant for the equalization step.

26. A method as claimed in claim 25, wherein the time constants are selected so that adaptation through the equalization step is significantly faster than adaptation through adjusting the timing of the analog-to-digital converter.

27. A method as claimed in claim 24, further comprising amplifying the received signal through a variable gain amplifier prior to digitizing it.

28. A method as claimed in claim 25, further comprising selecting for the variable gain amplifier a control word to maximize the quantization bit resolution for the analog-to-digital converter and to maintain the output of the analog-to-digital converter in an optimal range.

29. A method as claimed in claim 25, further comprising monitoring the output of the analog-to-digital converter, and enabling the equalization step on the first incoming “1” or “−1” symbol after detecting a signal from the analog-to-digital converter.
